(19) United States
(12) Patent Application Publication
(10) Pub. No.: US 2026/0302555 A1
(43) Pub. Date: Oct. 1, 2026

(54) Secondary Battery and Method for Joining Electrode Lead

(71) Applicant: LG Energy Solution, Ltd., Seoul (KR)

(72) Inventors: Eui Jin Hong, Daejeon (KR); Jae Won Moon, Daejeon (KR); Min Soo Park, Daejeon (KR)

(73) Assignee: LG Energy Solution, Ltd., Seoul (KR)

(21) Appl. No.: 19/572,201

(22) Filed: Mar. 19, 2026

(30) Foreign Application Priority Data
Apr. 1, 2025 (KR) 10-2025-0042447
Mar. 5, 2026 (KR) 10-2026-0040039

(51) Int. Cl. H01M 50/536; B23K 26/211; H01M 50/533; H01M 50/534; B23K 101/38; B23K 103/10; B23K 103/12; B23K 103/16

(52) U.S. Cl. CPC H01M 50/536; B23K 26/211; H01M 50/533; H01M 50/534; B23K 2101/38; B23K 2103/10; B23K 2103/12; B23K 2103/172; H01M 2220/20

(57) ABSTRACT

A method of joining an electrode lead includes: first stacking a welding metal plate and a tab of a secondary battery; first welding the welding metal plate and the tab stacked with each other at the first stacking, thereby forming a welding intermediate; filling a welding hole formed in the welding intermediate, with a welding material; second stacking the welding intermediate filled with the welding material and a metal lead; and second welding the welding intermediate and the metal lead stacked with each other at the second stacking.

### CROSS-REFERENCE TO RELATED APPLICATIONS

This application is based on and claims priority from Korean Patent Application No. 10-2025-0042447 filed on Apr. 1, 2025 and Korean Patent Application No. 10-2026-0040039 filed on Mar. 5, 2026, with the Korean Intellectual Property Office, the disclosure of which is incorporated herein in its entirety by reference.

### TECHNICAL FIELD

Embodiments of the present disclosure relate to a secondary battery and a method of joining an electrode lead of the secondary battery.

### BACKGROUND

In general, unlike a primary battery that is not rechargeable, a secondary battery refers to a battery capable of repeatedly charging and discharging, and is widely used in electronic devices such as mobile phones, notebook computers, and camcorders, or in electric vehicles.

In general, types of the secondary battery include a nickel cadmium battery, a nickel metal hydride battery, a lithium ion battery, and a lithium ion polymer battery. Such secondary batteries are applied to and used not only in small-sized products such as digital cameras, P-DVDs, MP3 players, mobile phones, PDAs, portable game devices, power tools, and e-bikes, but also in large-sized products requiring high output, such as electric vehicles or hybrid vehicles, and in power storage devices and backup power storage devices for storing surplus generated power or renewable energy.

In order to manufacture such secondary batteries, first, an electrode active material slurry is applied to a positive electrode current collector and a negative electrode current collector to manufacture a positive electrode and a negative electrode, and the positive electrode and the negative electrode are disposed on both sides of a separator to form an electrode assembly having a predetermined shape. Then, the electrode assembly is accommodated in a battery case and sealed after an electrolyte is injected.

According to the shape of the battery case, the secondary battery may be classified into a cylindrical battery or a prismatic battery in which an electrode assembly is embedded in a cylindrical or prismatic metal can, and a pouch-type battery in which an electrode assembly is embedded in a pouch-type case made of a laminate sheet.

Meanwhile, in manufacturing the secondary batteries, ultrasonic welding, laser welding, or resistance welding is used to weld an electrode tab and a metal lead. In addition, joining the electrode tab and the metal lead without damage to materials by using such welding methods is an important factor in maintaining appropriate joining strength and contact resistance.

### SUMMARY

Embodiments of the present disclosure provide a method of joining an electrode lead capable of solving various problems occurring in a process of welding a metal lead and a tab of a secondary battery, and a secondary battery including an electrode lead formed by the method.

According to an embodiment of the present disclosure, a method of joining an electrode lead may include: first stacking the welding metal plate and a tab of a secondary battery; first welding the welding metal plate and the tab stacked with each other at the first stacking to form a welding intermediate; filling a welding hole formed in the welding intermediate, with a welding material; second stacking the welding intermediate filled with the welding material and a metal lead; and second welding the welding intermediate and the metal lead stacked with each other at the second stacking.

According to another embodiment of the present disclosure, a secondary battery may include an electrode lead formed by the method described above and an electrode assembly.

According to yet another embodiment of the present disclosure, a secondary battery may include an electrode assembly; a tab extending from the electrode assembly; a welding metal plate coupled to the tab; a metal lead coupled to the welding metal plate; and a welding material filled in a welding hole formed in the tab.

According to an embodiment of the present disclosure, a tab of a secondary battery formed of a composite current collector may be joined to a metal lead while maintaining appropriate strength and minimizing damage applied to the tab by laser welding, and thus, a secondary battery having a tab that maintains appropriate joining strength may be produced.

### BRIEF DESCRIPTION OF THE DRAWINGS

The following drawings attached hereto exemplify embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a diagram schematically illustrating an internal structure of a pouch-type secondary battery.

FIG. 2 is a flowchart illustrating a method of joining an electrode lead, according to one embodiment of the present disclosure.

FIG. 3 is a cross-sectional view illustrating a layered structure of a composite current collector constituting a tab of the secondary battery, according to one embodiment of the present disclosure.

FIG. 4 is a diagram illustrating a tab of the secondary battery and a welding metal plate in a method of joining an electrode lead, according to one embodiment of the present disclosure.

FIG. 5 is a diagram illustrating a first welding step of welding a welding metal plate and a tab in the method of joining an electrode lead, according to one embodiment of the present disclosure.

FIG. 6 is a diagram illustrating a welding intermediate formed by the method of joining an electrode lead, according to one embodiment of the present disclosure.

FIG. 7 is a diagram illustrating a filling step of filling a welding material in the method of joining an electrode lead, according to one embodiment of the present disclosure.

FIG. 8 is a diagram illustrating a second welding step of the method of joining an electrode lead, according to one embodiment of the present disclosure.

FIG. 9 is a diagram illustrating a state where a tab and an electrode lead are joined by the method of joining an electrode lead, according to one embodiment of the present disclosure.

FIG. 10 is a block diagram illustrating a hardware configuration implementing a controller included in an electrode lead joining apparatus, according to the present disclosure.

FIG. 11 is a schematic perspective view illustrating a vehicle including the secondary battery including the metal lead manufactured by the method according to one embodiment of the present disclosure.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

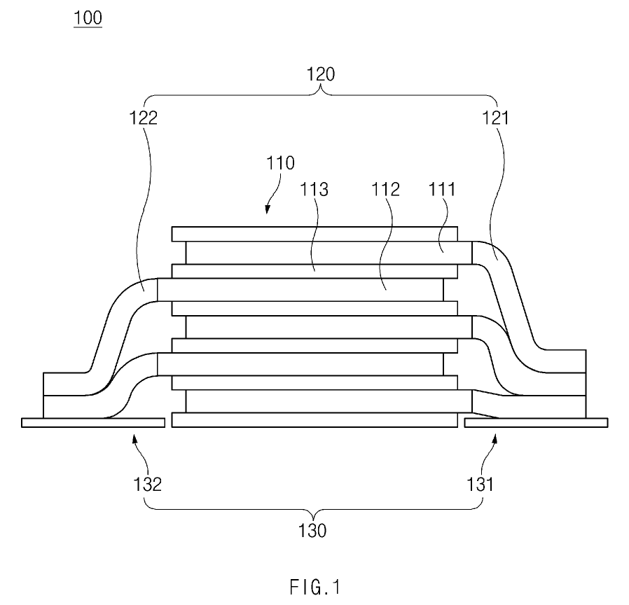

FIG. 1 is a diagram schematically illustrating an internal structure of a pouch-type secondary battery 100. The pouch-type secondary battery 100 includes an electrode assembly 110 formed by alternately stacking a positive electrode 111, a negative electrode 112, and a separator 113, and includes a pouch-type exterior material in which the electrode assembly 110 is accommodated. Electrode tabs 120 having the same polarity are gathered and welded together, and the welded electrode tabs 120 are then additionally welded to respective metal leads 130. That is, positive electrode tabs 121 are welded to each other, negative electrode tabs 122 are welded to each other, the welded positive electrode tabs 121 are welded again to a positive electrode lead 131, and the welded negative electrode tabs 122 are welded again to a negative electrode lead 132. One end of each of the metal leads 130 has a structure protruding to the outside of the pouch so as to be electrically connectable to an external device. Meanwhile, although a pouch-type secondary battery is taken as an example in the present embodiment, the present disclosure may also be applied to other types of secondary batteries having a similar tab structure.

In manufacturing the positive electrode 111 and the negative electrode 112 of the secondary battery 100, a single metal foil such as aluminum (Al) or copper (Cu) has been used as a current collector to which an electrode slurry (a positive electrode slurry or a negative electrode slurry) is applied. In recent years, however, a composite current collector having a sandwich structure such as metal–polymer–metal has been used. The composite current collector has advantages such as improved electrode stability and reduced weight, and thus, has attracted considerable attention as a next-generation material for separators.

In order to manufacture a cell using the composite current collector, a welding process is required for connecting an electrode tab of the composite current collector and a metal lead. Conventional welding processes include ultrasonic welding in which welding is performed using heat and friction, and laser welding in which metal is melted and welded using a laser as a heat source.

When a composite current collector tab and a metal lead are connected by ultrasonic welding, a problem arises in that significant friction is generated at a portion where the metal lead and the composite current collector are in contact with each other due to vibration generated during welding, thereby damaging the composite current collector tab. In addition, when a composite current collector tab and a metal lead are connected by laser welding, for example, only traces of laser irradiation remain and welding is not performed when a relatively low energy is applied. In contrast, when laser welding is performed using a relatively high energy, only a hole is formed at a position irradiated with the laser and welding is not achieved.

In consideration of the above issues, the present disclosure provides a method capable of connecting a composite current collector tab to a metal lead by laser welding while maintaining appropriate joining strength and minimizing damage applied to the composite current collector, and capable of producing a secondary battery having a tab that maintains appropriate joining strength.

Hereinafter, embodiments of the present disclosure will be described in detail with reference to the accompanying drawings so that a person having ordinary skill in the art to which the present disclosure pertains can readily practice the present disclosure.

For reference, the description of one embodiment may be equally applied to embodiments described below unless the embodiments are mutually inconsistent.

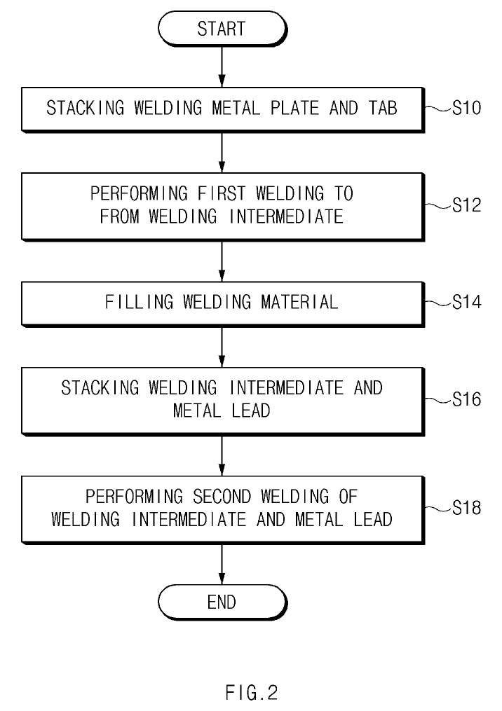

FIG. 2 is a flowchart illustrating a method of joining an electrode lead, according to the first embodiment of the present disclosure.

Referring to FIG. 2, the method of joining an electrode lead, according to one embodiment of the present disclosure, may include a step of preparing a welding metal plate 40 and stacking the welding metal plate 40 with a tab 20 of a secondary battery (S10), a first welding step of welding the stacked welding metal plate 40 and the tab 20 to form a welding intermediate M (S12), a step of filling a welding material W1 (S14), a step of stacking the welding intermediate M filled with the welding material W1 with a metal lead 30 (S16), and a second welding step of welding the stacked welding intermediate M and the metal lead 30 (S18). In the description according to one embodiment of the present disclosure, an electrode lead may refer to a structure in which the tab 20, the metal lead 30, and the metal plate 40 are stacked.

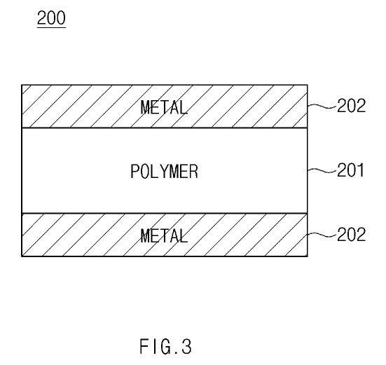

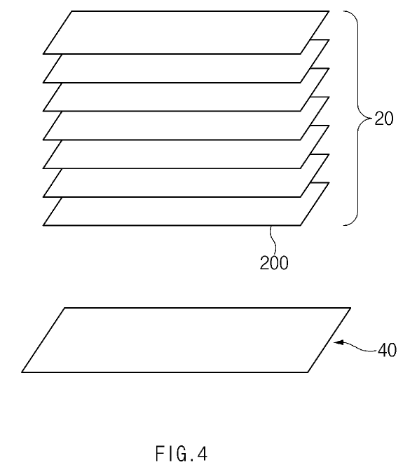

FIG. 3 is a cross-sectional view illustrating a layered structure of a composite current collector 200 constituting a tab 20 of the secondary battery, according to one embodiment of the present disclosure. In addition, FIG. 4 is a cross-sectional view illustrating a layered structure of the tab 20 of the secondary battery and the welding metal plate 40, according to one embodiment of the present disclosure.

Referring to FIGS. 3 and 4, the tab 20 of the secondary battery, according to one embodiment of the present disclosure may include a plurality of composite current collectors 200 in a film form. Each composite current collector 200 may include at least one metal layer 202 and at least one polymer layer 201. According to one embodiment, the at least one metal layer 202 included in the composite current collector 200 may be formed of two metal layers, which may be respectively disposed at a lowermost side and an uppermost side of the at least one polymer layer 201. Unlike a conventional electrode foil manufactured from a single material such as aluminum or copper, the composite current collector 200 may be manufactured in a sandwich structure in which metal layers 202 are stacked on both sides with a polymer layer interposed therebetween.

A polymer layer 201 included in the composite current collector 200 may be formed of, for example, at least one selected from polypropylene, polyimide, polyethylene naphthalate, polyethylene terephthalate, or any combination thereof. The metal layer 202 may be formed of, for example, one selected from copper, aluminum, or a combination thereof. According to one embodiment, the metal layer 202 may be manufactured by being thinly coated on a surface of the polymer layer 201 through, for example, a physical vapor deposition (PVD) process or an electrolytic plating process.

The welding metal plate 40 may be formed of at least one selected from aluminum, copper, an aluminum alloy, a copper alloy, or any combination thereof. For example, the welding metal plate 40 and the tab 20 may be formed in a plate shape, and the width of the welding metal plate 40 may be greater than the width of the tab 20. According to one embodiment, a single tab plate 200 may be used as the tab 20, or a plurality of tab plates 200 may be stacked and fixed to each other to constitute the tab 20. In addition, the welding metal plate 40 and the tab 20 may have a rectangular shape elongated in one direction when viewed along the up-and-down direction.

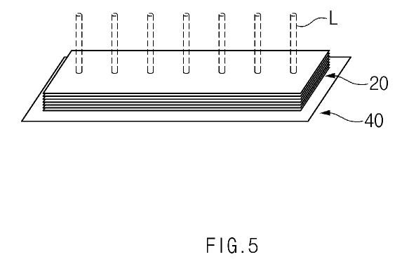

FIG. 5 is a diagram illustrating a step of stacking and welding the welding metal plate 40 and the tab 20 in the method of joining an electrode lead, according to one embodiment of the present disclosure.

The method of joining an electrode lead, according to one embodiment of the present disclosure, may include a step of stacking the welding metal plate 40 and the tab 20 (S10). As illustrated in FIG. 5, the tab 20 may be placed on the welding metal plate 40 to be stacked. The tab 20 may be stacked downward from an upper side of the welding metal plate 40, and when viewed from a downward direction, the tab 20 may entirely overlap with the welding metal plate 40, so that the welding metal plate 40 appears to surround the tab 20.

The method of joining an electrode lead, according to one embodiment of the present disclosure, may include a first welding step of, after stacking the welding metal plate 40 and the tab 20, welding the stacked welding metal plate 40 and the tab 20 to form a welding intermediate M (S12).

In the first welding step (S12), a laser welding may be used to weld the welding metal plate 40 and the tab 20. In the first welding step (S12), a laser beam L irradiated to the tab 20 and the welding metal plate 40 may be irradiated along the up-and-down direction. In FIG. 5, the laser beam L is irradiated downward. A plurality of laser beams L may be provided. The plurality of laser beams L may be spaced apart from each other and arranged along a longitudinal direction of the tab 20 and the welding metal plate 40. The plurality of laser beams L may be spaced apart from each other at equal intervals.

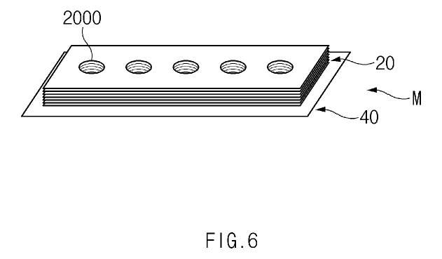

FIG. 6 is a diagram illustrating a welding intermediate M formed by the method of joining an electrode lead, according to one embodiment of the present disclosure.

The welding intermediate M is formed by welding the stacked tab 20 and the welding metal plate 40 so as to be joined to each other. In the welding intermediate M formed by the method of joining an electrode lead, according to one embodiment of the present disclosure, a welding hole 2000 may be formed. The welding hole 2000 is a hole formed in the welding intermediate M by a welding operation of the tab 20 and the welding metal plate 40 using, for example, the laser beam L. The welding hole 2000 may be formed by recessing a portion of the tab 20 of the welding intermediate M. The welding hole 2000 may be formed in a circular shape when viewed along a downward direction, which is a direction in which the tab 20 is stacked on the welding metal plate 40. The welding hole 2000 may be formed at a position to which the laser beam L is irradiated on the tab 20 and the welding metal plate 40. Accordingly, a plurality of welding holes 2000 may be formed, and the centers of the plurality of welding holes 2000 may be spaced apart from each other by intervals corresponding to the intervals at which the plurality of laser beams L are spaced apart from each other.

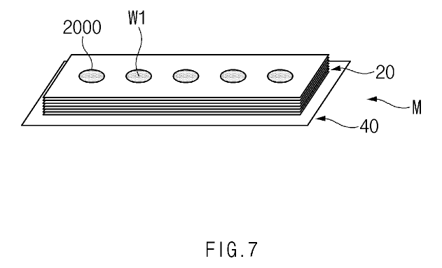

Referring to FIG. 7, the method of joining an electrode lead, according to one embodiment of the present disclosure, may include a step of filling a welding material W1 (S14). The step of filling the welding material W1 (S14) is a step of filling the welding material W1 into the welding hole 2000 formed in the welding intermediate M in the first welding step S12.

According to one embodiment, the welding material W1 may be formed of at least one selected from aluminum, copper, an aluminum alloy, a copper alloy, or any combination thereof. The material of the welding material W1 may be the same as the material of the welding metal plate 40. The welding material W1 may be formed of one selected from metal powder, at least one metal plate, or a combination thereof.

According to one embodiment, the step of filling the welding material W1 (S14) may include filling the welding material W1 to a height of one third or more and equal to or less than a height of the tab 20. When the welding material W1 is filled to a height smaller than one third of the height of the tab 20, an amount of metal provided for welding may be insufficient, and when the welding material W1 is filled to a height greater than the height of the tab 20, unnecessary metal spatter may be generated on the surfaces of the tab 20. Here, the height is a value measured along an up-and-down direction, which is a stacking direction of the components. The welding material W1 may be filled into all of the plurality of welding holes 2000.

When welding is performed using only the tab 20, the welding may not be achieved with sufficient strength due to an insufficient amount of metal. Accordingly, by filling the welding material W1 into the welding hole 2000, a sufficient amount of metal may be supplied such that welding is performed with appropriate strength.

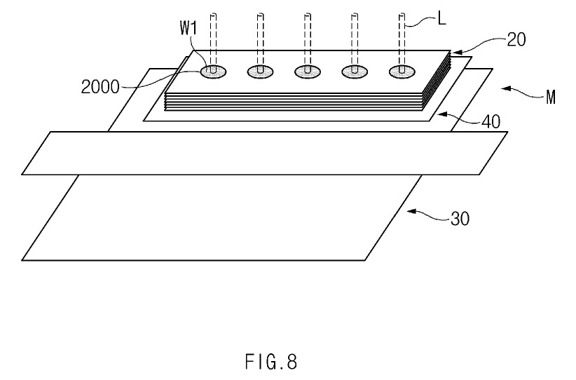

FIG. 8 is a diagram illustrating a stacking step (S16) and a second welding step (S18) of the method of joining an electrode lead, according to one embodiment of the present disclosure.

The method of joining an electrode lead, according to one embodiment of the present disclosure, may include a stacking step (S16) of stacking the welding intermediate M filled with the welding material W1 with the metal lead 30. As illustrated, according to one embodiment, the welding intermediate M filled with the welding material W1 may be placed on the metal lead 30 to be stacked. According to one embodiment, the welding intermediate M and the metal lead 30 may be stacked such that the portions corresponding to the welding holes 2000 entirely overlap with the metal lead 30 when viewed along the up-and-down direction.

The method of joining an electrode lead, according to one embodiment of the present disclosure, may include a second welding step of welding the stacked welding intermediate M and the metal lead 30 (S18).

Similar to the first welding step (S12), in the second welding step (S18), a laser welding may be used to weld the welding intermediate M and the metal lead 30. In the second welding step (S18), the laser beam L irradiated to the tab 20 and the welding metal plate 40 may be irradiated along the up-and-down direction. In FIG. 8, the laser beam L is irradiated downward. A plurality of laser beams L may be provided. The plurality of laser beams L may be spaced apart from each other and arranged along the longitudinal direction of the welding intermediate M. The plurality of laser beams L may be spaced apart from each other at equal intervals. The plurality of laser beams L may be irradiated to the welding material W1 filled in the welding holes 2000.

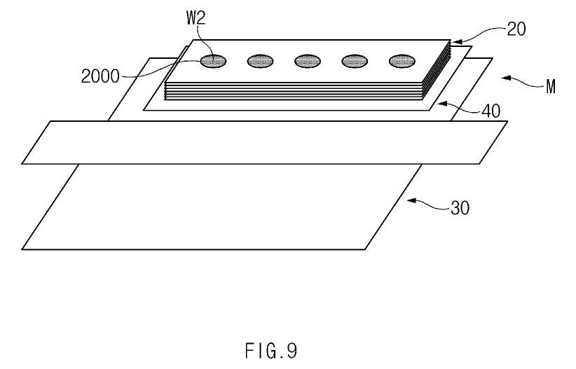

FIG. 9 is a diagram illustrating a state where the tab 20 and the electrode lead are joined by the method of joining an electrode lead, according to one embodiment of the present disclosure.

By the second welding step (S18), the welding intermediate M filled with the welding material W1 is welded to the metal lead 30, so that the tab 20 and the metal lead 30 may be joined to each other as illustrated. By the second welding step (S18), a welding material W2 may be welded to the tab 20, the welding metal plate 40, and the metal lead 30.

In order for the laser welding to be perfectly performed, a trace referred to as a backside weld bead needs to remain on a rear surface of a welding target material. When the tab 20, which includes a composite current collector of which the metal layer 202 constitutes a portion, and the metal lead 30, which has a relatively large thickness, are directly welded to each other, laser output power needs to be increased to instantaneously melt the metal lead 30 having the large thickness. When the welding is performed under such conditions, the thin metal layer 202 of the composite current collector may scatter to surrounding regions due to the high laser output power, and thus, the tab 20 and the metal lead 30 are difficult to be directly welded to each other. In this case, when the welding metal plate 40 is first laser-welded to the tab 20 and the metal lead 30 is then welded thereto, the welding may be performed by irradiating a laser with lower output power. As a result, the final product of the method of joining an electrode lead, according to one embodiment, has a layered structure of the tab 20-the welding metal plate 40-the metal lead 30. In addition, a resulting secondary battery is formed in a shape in which the welding metal plate 40 and the welding material W2 are further disposed in the secondary battery 100 of FIG. 1, and may include the electrode assembly, the tab 20 extending from the electrode assembly, the welding metal plate 40 coupled to the tab 20, and the metal lead 30 coupled to the welding metal plate 40.

The method of joining an electrode lead, according to one embodiment of the present disclosure, may be implemented by an electrode lead joining apparatus. The electrode lead joining apparatus may include a worktable configured to fix the metal lead 30 and the tab 20, a laser irradiation unit configured to irradiate the laser beam L to the tab 20 fixed on the worktable, a moving unit configured to position respective components at desired positions by moving the worktable and/or the laser irradiation unit or filling the welding material W1, and a processor electrically connected to the moving unit and the laser irradiation unit to transmit control commands. The worktable may include a clamp for gripping and fixing the metal lead 30, the tab 20, and the welding metal plate 40. The moving unit may be a robot arm having a high degree of freedom, or may perform rotational and linear motions by including a linear guide or a motor. The laser irradiation unit may include a light source and an amplifier.

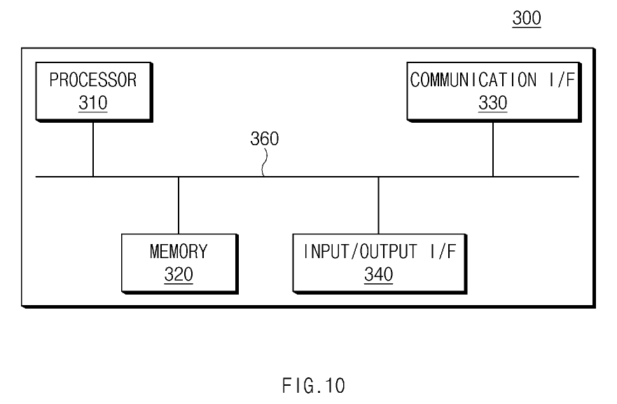

FIG. 10 is a block diagram illustrating a hardware configuration implementing a controller included in an electrode lead joining apparatus, according to the present disclosure.

A control unit 300, according to one embodiment of the present disclosure, may include a processor 310. The processor 310 is a component including a device capable of performing logical operations for executing control commands, and may include an integrated circuit (IC), an application specific integrated circuit (ASIC), a field programmable gate array (FPGA), or a central processing unit (CPU). The processor 310 may be connected to various components of an electrode lead joining apparatus, according to one embodiment of the present disclosure, to transmit signals corresponding to control commands to the respective components, and may be connected to various sensors or acquisition units to receive acquired information in a form of signals. Since the processor 310 may be electrically connected to the respective components, the processor 310 may be connected through wires, or may communicate with the respective components through a communication module capable of wireless communication.

The control unit 300 may further include a memory 320. Control commands executed by the processor 310 may be stored in the memory 320 and utilized. The memory may be a device such as a hard disk drive (HDD), a solid state drive (SDD), a server, a volatile medium, or a non-volatile medium, but is not limited thereto. In addition, the memory 320 may further store data required for the processor 310 to perform operations. In addition, the control unit 300 may include a communication I/F 330 and an input/output I/F 340. Further, the control unit 300 may further include a bus 360 to electrically connect components such as the processor 310 and the memory 320 and to allow the components to transmit and receive electrical signals to and from each other.

The electrode lead joining apparatus may receive required information through an input unit. The input unit may receive information by including means such as buttons, switches, or a touch screen, and may also receive information by scanning codes or the like by including a barcode scanner, a QR code scanner, or an RFID scanner. Information on an electrode assembly entering the electrode lead joining apparatus may be input through the input unit. The information input through the input unit may be transmitted to the processor 310 through the communication I/F 330 and the input/output I/F 340 of the control unit 300.

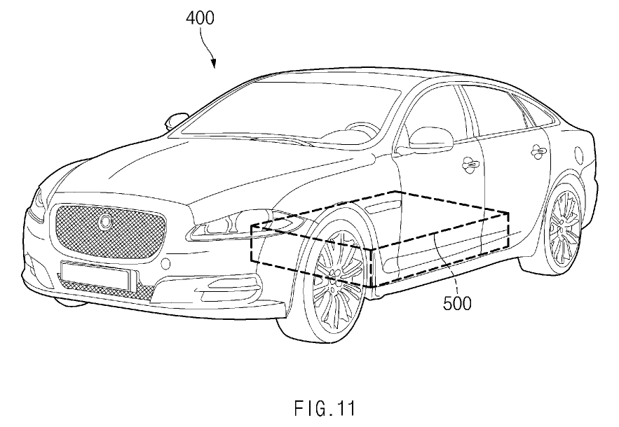

Referring to FIG. 11, a vehicle 400 according to one embodiment of the present disclosure may include one or more battery packs 500 including a secondary battery manufactured by the methods according to the embodiments as described above. The vehicle 400 according to the present disclosure may be, for example, an electric vehicle, a hybrid vehicle, or a plug-in hybrid vehicle. The vehicle 400 includes not only a four-wheeled vehicle but also various types of vehicles such as a two-wheeled vehicle or a three-wheeled vehicle. The vehicle 400 may operate by receiving power supplied from the battery pack 500, according to one embodiment of the present disclosure.

The above description is merely illustrative of the technical spirit of the present disclosure, and a person having ordinary skill in the art to which the present disclosure pertains will appreciate that various modifications and variations may be made without departing from the essential characteristics of the present disclosure.

What is claimed is:

1. A method of joining an electrode lead, the method comprising:
first stacking a welding metal plate and a tab of a secondary battery;
first welding the welding metal plate and the tab stacked with each other at the first stacking, thereby forming a welding intermediate;
filling a welding hole, formed in the welding intermediate, with a welding material;
second stacking the welding intermediate filled with the welding material and a metal lead; and
second welding the welding intermediate and the metal lead stacked with each other at the second stacking.

2. The method according to claim 1, wherein the welding material is formed of at least one selected from aluminum, copper, an aluminum alloy, a copper alloy, or any combination thereof.

3. The method according to claim 1, wherein the welding material is formed of one selected from metal powder, at least one metal plate, or a combination thereof.

4. The method according to claim 1, wherein the tab includes a composite current collector film having at least one metal layer and at least one polymer layer.

5. The method according to claim 4, wherein the at least one metal layer is formed of two metal layers respectively disposed at a lowermost side and an uppermost side of the at least one polymer layer.

6. The method according to claim 4, wherein the at least one polymer layer is formed of at least one selected from polypropylene, polyimide, polyethylene naphthalate, polyethylene terephthalate, or any combination thereof.

7. The method according to claim 1, wherein the forming the welding intermediate includes laser-welding the welding metal plate and the tab.

8. The method according to claim 1, wherein the welding hole is formed in a circular shape.

9. The method according to claim 1, wherein in the filling, the welding material is filled to a height of one third or more and equal to or less than a height of the tab.

10. A secondary battery comprising:
an electrode lead formed by the method of claim 1; and
an electrode assembly connected to the electrode lead.

11. A secondary battery comprising:
an electrode assembly;
a tab extending from the electrode assembly;
a welding metal plate coupled to the tab;
a metal lead coupled to the welding metal plate; and
a welding material filled in a welding hole formed in the tab.

12. The secondary battery according to claim 11, wherein the tab includes a composite current collector film having at least one metal layer and at least one polymer layer.

13. A vehicle comprising the secondary battery of claim 12.
